(19) United States
(12) Patent Application Publication
(10) Pub. No.: US 2003/0225523 A1
(43) Pub. Date: Dec. 4, 2003

(54) Delineation and compensation for near surface anomalies in the seismic CMP method (2-D and 3-D) using spatially fixed patterns

(76) Inventors: Vitaly Stepanovich Kozyrev, Moscow (RU); Alexander Petrovich Zhukov, Moscow (RU); Ilya Petrovich Korotkov, Narofominsk (RU); Artem Alexandrovich Zhukov, Moscow (RU); Tagir Edgartovich Galikeev, Golden, CO (US)

Correspondence Address: Tagir Galikeev, 686 Entrada Dr, Golden, CO, 80401, US

(21) Appl. No.: 10/157,392

(22) Filed: May 30, 2002

(51) Int. Cl. G01V 1/00

(52) U.S. Cl. 702/14

(57) ABSTRACT

Method declared in this invention relates to processing of 2D and 3D seismic exploration data. More particularly, it relates to the family of static correction methods used for delineation and compensation of near-surface heterogeneities. Time anomalies, caused by such heterogeneities, are detected, analyzed and removed from following processing sequence. If not removed, they mask useful information about true position of geological structures in time. Near surface anomalies are delineated via construction and interpretation of sets of surface-consistent time sections (2D) or cubes (3D), which are resulted from stacking seismic traces with common receiver point (CRP) or common source point (CSP). Combinations of different surface position of seismic sources and receivers on time sections are used to discriminate between surface anomaly and depth structure. Special case of time sections is the one where spatially fixed patterns of sources and receivers are used. This case is primarily used for 3D. Analysis of stacked time sections or volumes and estimation of time shifts is performed interactively by using specially designed software system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING APPENDIX

Not Applicable

### BACKGROUND OF THE INVENTION.

This invention relates to seismic exploration using common mid point method (CMP), and, more particularly, to the delineation of near surface heterogeneities or static anomalies on the stage of seismic data processing. In U.S. Pat. No. 3,940,734 to Blum, the identification of near surface or static anomalies in seismic data by producing two or more common depth point (CDP) stacks is disclosed. The near surface anomaly manifests itself through the time difference of the same seismic event on CSP and CRP created using different stacking patterns. Time inconsistence for the same event on different offset-limited CDP stacks with partial fold coverage could also indicate the presence of near surface anomaly.

Unfortunately, methods that can compensate for static shifts caused by larger, medium- to long-wavelength anomalies did not exist until this time. This can be explained by uncertainty increase in static shifts estimation with wavelength increase (Wiggins R. A. et al., 1976). To reduce the uncertainty additional information should be used. Interactive correction methods are needed in addition to a plethora of existing automatic static correction methods, which compensate reliably only for the short-period static shifts. Geophysicists do not interpret raw seismic data due to the large volume. It is more efficient to do analysis and interpretation on the processed stacked data. The benefits of seismic stacked data can be characterized by the following:

1. compressed information

2. increased signal-to-noise ratio

Methods determining static corrections using surface consistent stacks are well known and were described before (Disher D. A. and Naquin P. J., 1970; Ferree C. M. and Miller D. F. in U.S. Pat. No. 3,681,749, 1972). However these methods deal mostly with short-period static component.

### BRIEF SUMMARY OF THE INVENTION

Near surface anomalies in the 2-D and 3-D CMP method (short- and medium-period, boundaries of large heterogeneities) are delineated and compensated for by analyzing a suite of surface consistent time sections (volumes in 3-D), including sections with a fixed stacking pattern. The use of the spatially fixed pattern sections (fixed sources for CRP¹ and fixed receivers for CSP²) allows separation of components depending on the stacking system, i.e. components caused by shifts both in source and receiver domains when using CRP and CSP stacks. ¹Common Receiver Point ²Common Shot Point

### BRIEF DESCRIPTION OF THE DRAWINGS

The idea of the invention is described by the following figures:

FIG. 1: CSP stack formation using offset-limited data.

FIG. 2: fragment of the CSP stack formation with fixed receivers.

FIG. 3: CSP stack formation with fixed receiver patterns.

FIG. 4: delineation of near surface anomaly on offset-limited CRP stacks (a) and using fixed source patterns (b).

FIG. 5: offset-limited CRP time stacks with partial fold coverage using the right flank of acquisition spread.

FIG. 6: offset-limited CRP time stacks with partial fold coverage using the left flank of acquisition spread.

FIG. 7: comparison of CRP time stacks with fixed offset ranges and stacks constructed using fixed stacking patterns.

FIG. 8: an example of fixed source patterns in 3-D survey

FIG. 9: delineation of near surface anomalies on vertical sections through two CRP 3-D stacked volumes with different systems of fixed source patterns (a), same sections after surface consistent shifts (b).

### DETAILED DESCRIPTION OF THE INVENTION

Interactive analysis uses the suite of CSP and CRP surface consistent stacks (volumes in 3-D). Two kinds of stacks are utilized in the process—offset limited stacks and spatially fixed pattern stacks. The latter is the principally new concept. Spatially fixed pattern stacks allow studying the anomaly from different points and different angles. Time shifts, which are detectable at the same receiver or source points, are considered the static anomaly and need to be corrected for.

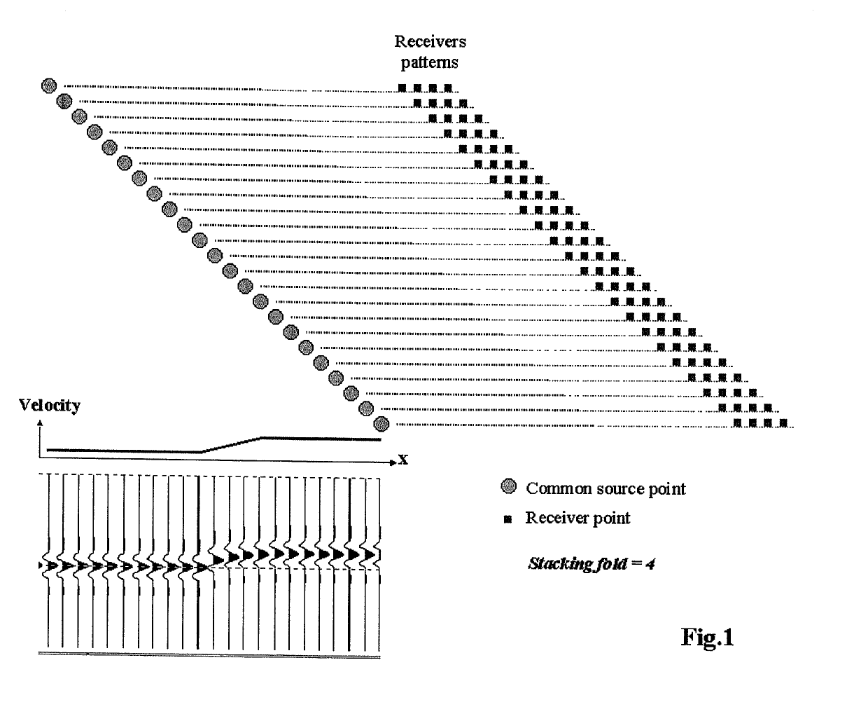

FIG. 1 illustrates the conventional CSP stacking with partial fold coverage: for each source point the traces, which had kinematic corrections applied and fall into the same offset range, are stacked (summed).

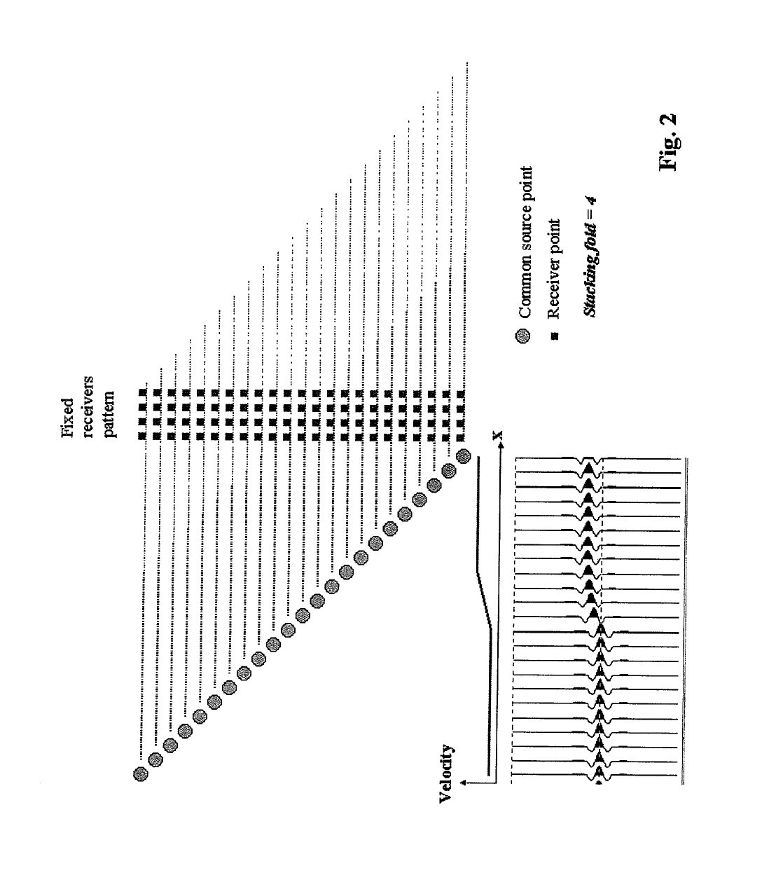

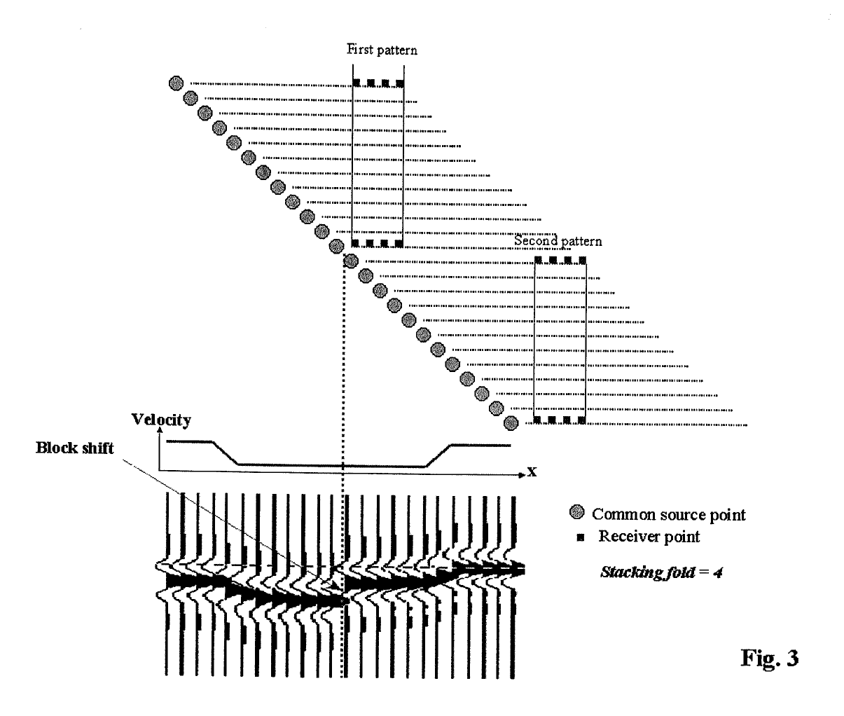

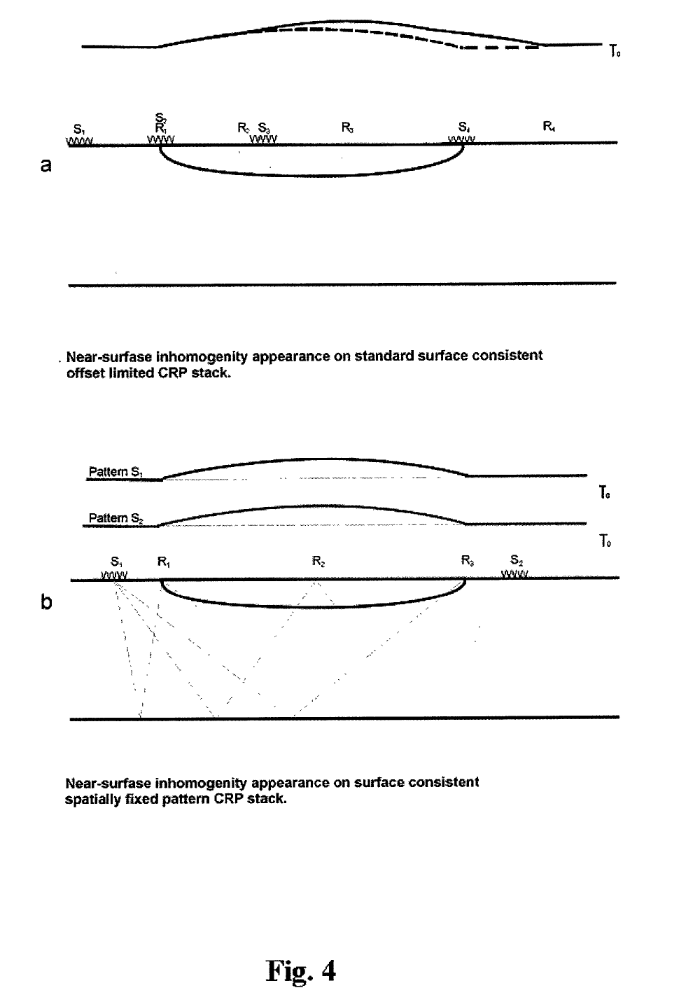

FIG. 2 explains the main idea behind the fixed patterns: stacking trace for particular sources is obtained by summing traces, which had kinematic corrections applied and belong to the same pattern of receiver points. The number of source points, for which the stacking traces can be obtained from one receiver pattern, depends on the acquisition spread and restrictions of offsets. Using the second receiver pattern (FIG. 3) forms CSP traces on the next part of the line. Since the first pattern of receivers (FIG. 3) is located above the low velocity anomaly and the second pattern is not, the time shift between the two trace groups can be identified and then removed by applying a block shift. Comparison of the different offset-limited CSP and CRP stacks helps in identification and separation of static anomalies from changing surface-independent components, including deep anomalies and components depending on stacking patterns. The latter is characterized by the influence of components depending on sources for CRP and receivers for CSP. They are small in values in the case of short-wavelength anomalies, but can double when anomalies are large (FIG. 4). This component also can have large values in the case of a sequence of short-wavelength anomalies of the same sign.

FIG. 4a illustrates the CRP stacking in the area characterized by a large near surface anomaly. The CRP stack assumes that the traces summed come from the sources within defined range of offsets from the receiver. On FIG. 4a groups of sources are marked by the points S1, S2, S3 and S4, which correspond to the representative center source position within each group. For simplicity the ray from the representative center source substitutes rays from each source. Rays are traced for receivers at points R1, R2, R3 and R4, crucial for understanding the reflection line t₀(double time) on the CRP stack. The shape of the reflection time curve is formed by two components: the static component depending on receiver points and the stacking pattern component, sources in this case. At point R1 the anomaly becomes evident on receivers (dashed line). At position R2 the sources are also located in the area of the anomaly resulting in additional time shift. At point R3 the time shift is almost twice as large. On the S4 to R4 layout the anomaly is evident only on the downgoing rays emanating from the sources. Therefore, R4 is the last point where anomaly is obvious.

Different types of CSP and CRP stacks with partial fold coverage help in identifying the component dependent on the stacking patterns, since it adds differently to the surface consistent shifts. Comparison of the stacks assists in determining, estimation and elimination of this component.

When the sources are fixed (FIG. 4b, points S1 and S2) the stacking pattern does not distort the shape of the anomaly. Fixed patterns created at different points around the anomaly help to illuminate the anomaly from different directions.

Comparison of offset-limited CSP and CRP stacks with fixed pattern stacks allows to determine and eliminate the component dependent on stacking groups of receiver and source accordingly, since on the fixed pattern stacks this component is evident only when comparing one pattern to another (block shift on FIG. 3).

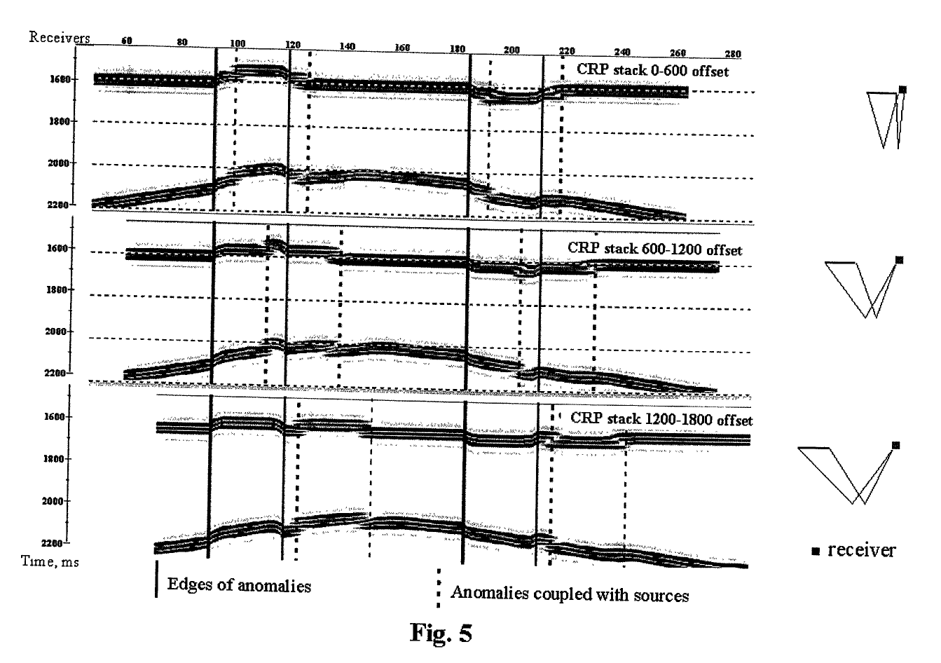

FIG. 5 shows CRP time stacks constructed using three different offset limited ranges for the modeled seismic line with two near surface anomalies. One anomaly is characterized by high velocity and the other by low velocity. The time magnitude of the low-velocity anomaly is smaller than that of the high-velocity anomaly. The stacks are collocated by the receiver positions. Left boundaries of the anomalies become evident on this combination of stacks. Anomalies are also evident on the intervals indicated by the dashed lines due to shifts along the downgoing rays emanating from the source positions. The shift of this component related to the source position is becoming larger with offsets and on the bottom stack the receiver and the source components of anomalies are separated.

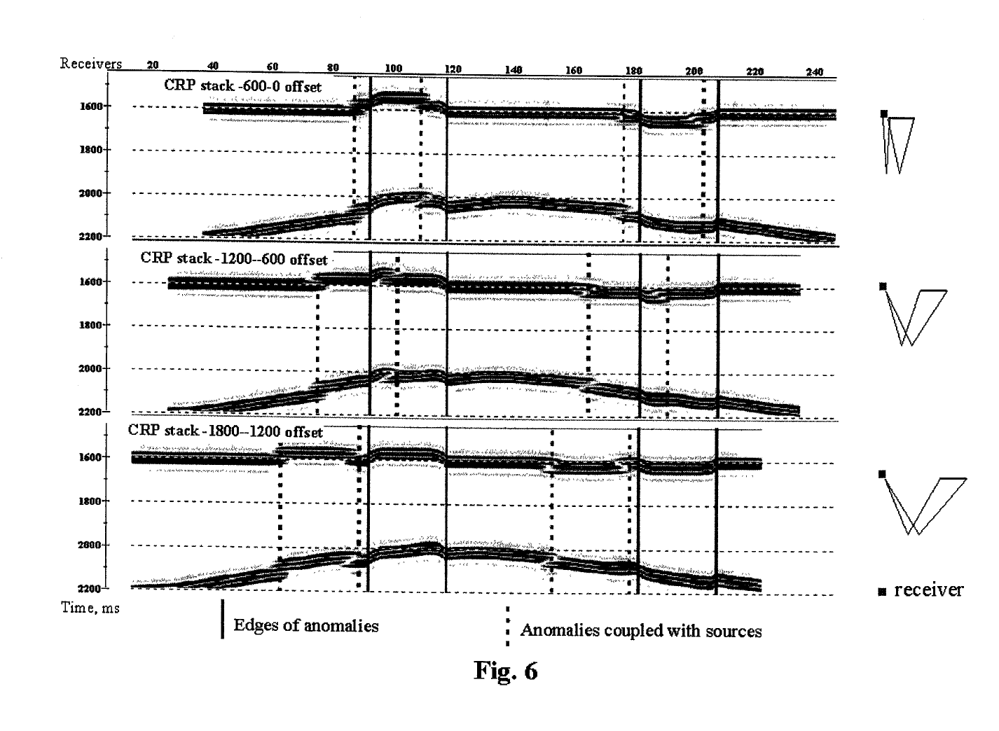

The time stacks in FIG. 6 are obtained using the same offset ranges for the left flank of the acquisition spread. The component related to the source-based stacking pattern is shifted to the opposite side and the right boundaries of the anomalies become evident.

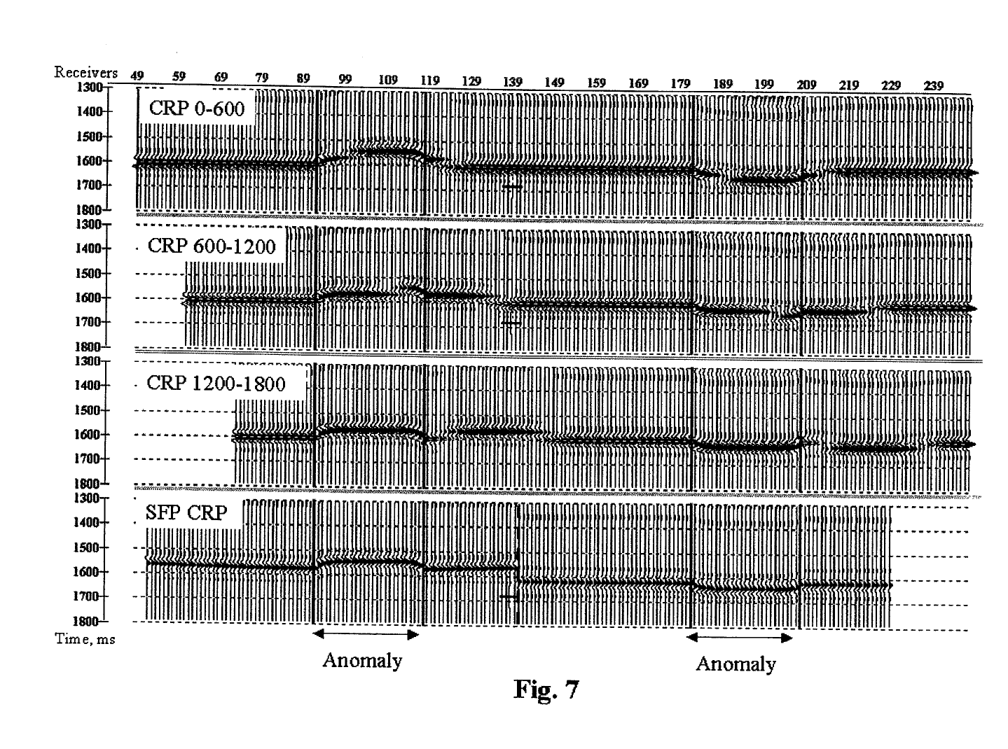

The upper three stacks of FIG. 7 are the same stacks as in FIG. 5 with shallow horizon only. The bottom is spatially fixed patterns CRP stacks. The difference between the fixed receiver patterns used in this case manifests itself through the time shift between the two fragments of the bottom stack (shown by the yellow line). Geometry of the anomalies are not distorted.

Using the combination of the stacks the form of anomalies are identified and the time shifts are computed, which then used as the static corrections. Observed anomalies do not coincide spatially when the stacks are collocated by CMPs that confirms the near surface nature of the anomalies.

In the case of 2-D experiment the system of patterns can be chosen along the line assuring continuous groups of stacked traces.

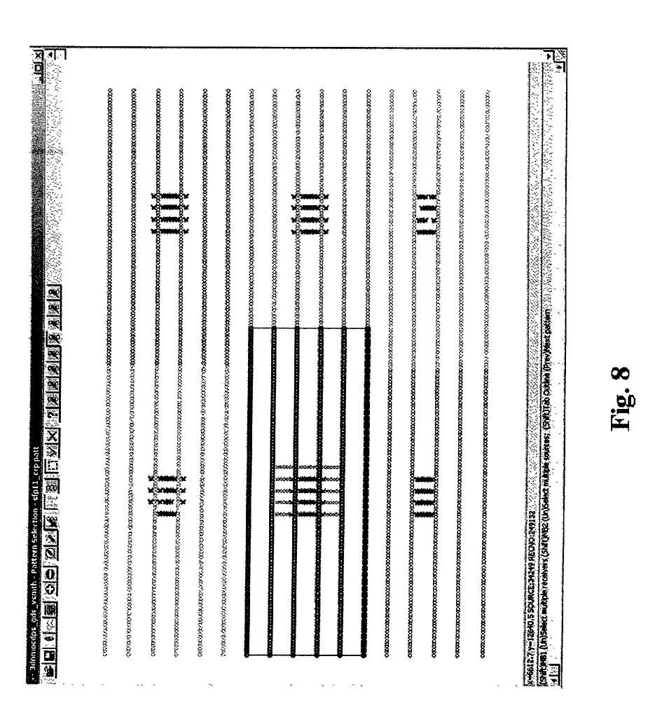

In the case of 3-D seismic data the system of spatial patterns forms the volume of surface consistent CSP/CRP traces. FIG. 8 shows an example of pattern selection for CRP stacking using the real seismic survey. Selected sources are shown in red and the corresponding receiver points are highlighted in blue. Sources shown in black are the sources, which could be included in the pattern to illuminate the same area. Selected source patterns for adjacent areas are highlighted in yellow. Selection of the patterns is done by using software with interactive GUI shown in FIG. 8.

Analysis requires at least two systems of patterns and the corresponding number of CSP/CRP stacking volumes created. The analysis is done on the vertical sections of the volumes cut by source/receiver lines.

The static shifts are determined by simultaneous interactive time shifts of traces in the same surface position on all stacks. The workstation-based software (hereafter “the system”) was developed to specifically form time sections and trace volumes, to interactively analyze them and to compute the static corrections. The special feature of the system is its ability to match computed stacks in a surface consistent and depth dependent manner and to shift traces in time simultaneously on all stacks subject to analysis.

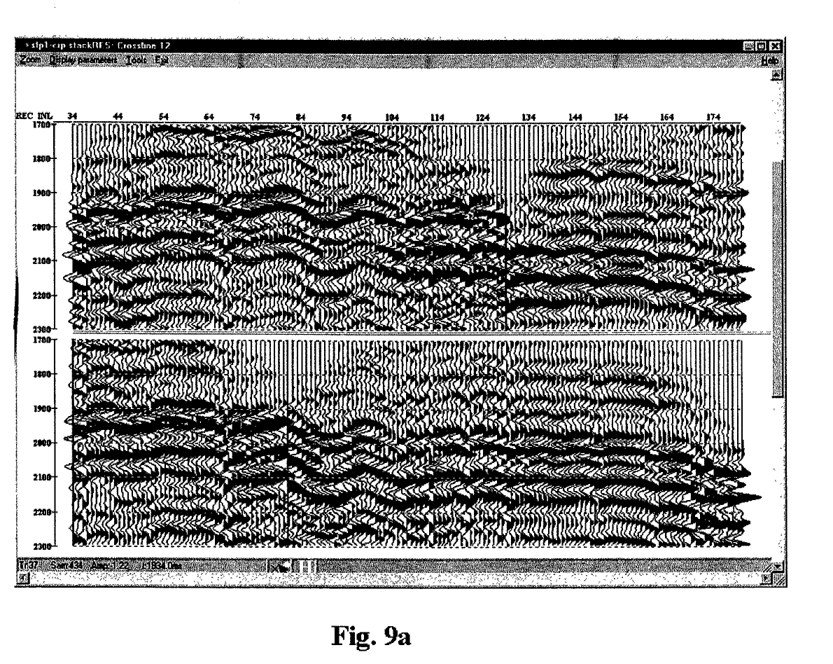

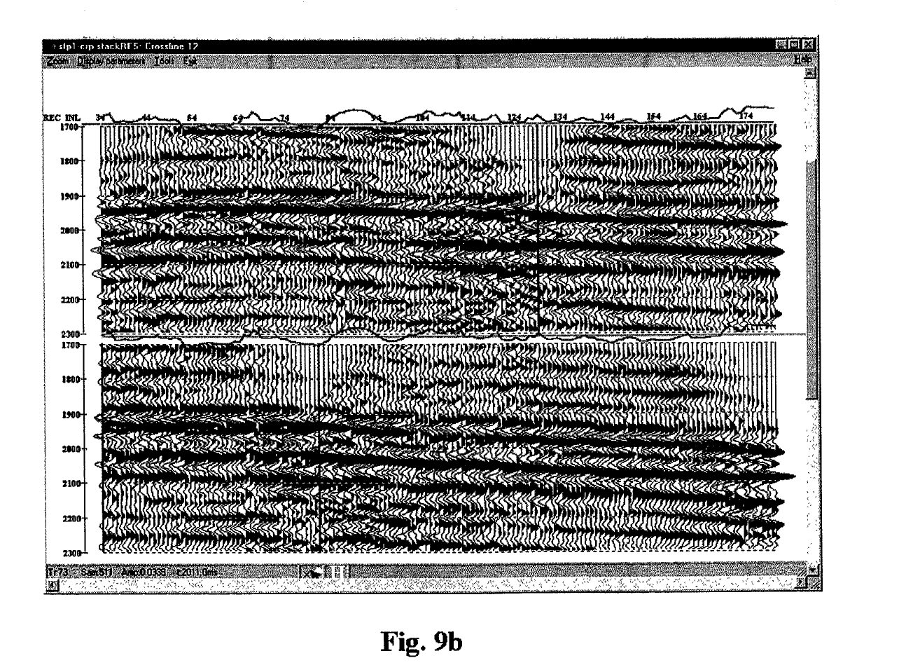

FIG. 9 illustrates an example of the slice analysis through the common receiver volume. The section is taken along the receiver line from a 3-D seismic survey where the near surface anomalies are present. Two stacks, subject to analysis (FIG. 9a), are obtained using different fixed source patterns. Coincidence of the anomalies representation on both time stacks allows classifying them as the static anomalies. Time stacks shown in Figure 9b are the same as in FIG. 9a only after the anomalies were corrected for by the time shifts.

What is claimed is:

1. The method of delineating of the near surface anomalies in 2-D seismic exploration, which consists of:
(a) the formation of the surface consistent stacks (CSP and CRP) using spatially fixed stacking patterns;
(b) the way of comparison of the stacks obtained with different sets of patterns and determination of surface consistent anomalies.

2. The method of delineating of the near surface anomalies in 2-D seismic exploration, which consists of:
(a) the formation of the surface consistent partial-offset stacks (CSP and CRP) using different offset-limited data;
(b) consecutive matching of surface consistent partial-offset stacks in a surface and subsurface consistent manner and determination of surface consistent anomalies.

3. The method of delineating of the near surface anomalies in 2-D seismic exploration, which consists of:
(a) the formation of surface consistent stacks (CSP and CRP) using both offset-limited data and fixed stacking patterns;
(b) consecutive matching of surface consistent stacks with depth consistent stacks and determination of surface consistent anomalies.

4. The method of delineating of the near surface anomalies in 3-D seismic exploration, which consists of:
(a) the formation of CSP and CRP stacked volumes using different spatially fixed patterns;
(b) comparison of vertical sections through these volumes obtained by cutting the volumes by the source lines and receiver lines using different sets of spatially fixed stacking patterns and determination of surface consistent anomalies;
(c) matching of anomalies using different source and receiver lines.

5. The system of delineation of the near surface anomalies in 2-D and 3-D seismic exploration, which consists of:
(a) ways of formation of separate surface consistent stacks in order to illuminate the anomaly from different observation angles;
(b) ways of formation of stacks (volumes in 3-D) with spatially fixed stacking patterns (receivers for CSP, sources for CRP);
(c) ways to interactively match and analyze the stacks with successive delineation of the surface and depth consistent anomalies;
(d) ways to determine the static shifts coincident with near surface anomalies.
